(19) United States
(12) Patent Application Publication
(10) Pub. No.: US 2008/0041555 A1
(43) Pub. Date: Feb. 21, 2008

(54) Method and Apparatus for Counteracting Stress in a Metal Product

(75) Inventors: Thomas M. Zurewich, Orangeville, PA (US); Edward M. Urban, Mt. Top, PA (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: INDALEX INC., Lincolnshire, IL (US)

(21) Appl. No.: 11/461,135

(22) Filed: Jul. 31, 2006

(51) Int. Cl. B60R 13/08; B32B 3/30; B22D 11/10

(52) U.S. Cl. 164/488

(57) ABSTRACT

A method for forming a metal product includes providing a counter stress feature in the metal product that is positioned to balance the stress in the metal product. The method includes providing a metal product having a neutral axis; providing a cutout in the metal product on a first side of the neutral axis; and providing a counter stress feature on a second side of the neutral axis. The position and size of the counter stress feature is predetermined such that the counter stress feature balances the stress introduced by the cutout. An extruded metal product includes a web having a neutral axis, at least one cutout in the web on a first side of the neutral axis, and at least one indentation in the web on a second side of the neutral axis. The at least one indentation is positioned to balance the stress introduced by the at least one cutout.

### BACKGROUND OF THE INVENTION

The present invention relates generally to metal products, and more particularly to a method for counteracting stress in an extruded metal product that has been punched, or otherwise deformed.

In the development and formation of engineered metal products, it is common to provide a cutout, notch or other feature at a particular location on the metal product. For instance, a metal railing may be provided with holes or notches at spaced locations for receiving bolts or attaching accessories to the railing. The holes, notches or other features may be provided in the metal product by a variety of methods, such as punching, coining, shearing, notching, forming or machining.

Problems arise when adding holes, notches and other features to metal products, because each of these features introduces a stress into the metal product. In the common situation where a stress is introduced on either side of the neutral axis of the metal product, the metal product tends to bow or bend along its length. This bending is exaggerated in cases where the metal product is long and narrow, such as a metal rail. Consequently, before the bowed metal products can be installed into a product or used in a desired application, they must be flattened by the manufacturer.

Manufacturers have tried a number of techniques for flattening a bowed metal product. One common method is to place the product into a roll bender, after it has been formed and stressed, to bend the product and flatten it out. The end result of this process is a flat product, however, the cost is increased with the need for additional roll bending equipment, and the extra bending step increases processing time. Other manufacturers experiment with different materials and thicknesses in an attempt to reduce the amount of bow in the product, but changes in these variables cannot eliminate the bow in the product.

### SUMMARY OF THE INVENTION

The aforementioned problems are overcome by the present invention, wherein a method for forming a metal product includes providing a counter stress feature in the metal product that is positioned to balance the stress in the metal product.

In one embodiment, the method includes providing a metal product having a neutral axis; providing a cutout in the metal product on a first side of the neutral axis; and providing a counter stress feature on a second side of the neutral axis. The position and size of the counter stress feature is predetermined such that the counter stress feature balances the stress introduced by the cutout.

In another embodiment, the method includes providing an extruded metal beam having a C-shaped cross section. In a more specific embodiment, the a plurality of the cutouts are included to define opposing notches located in first and second flange portions of the C-shaped cross section, and the counter-stress feature includes a plurality of indentations located on the rear surface of the central portion of the C-shaped cross section. The indentations may be conical in shape.

The present invention is also directed to an extruded metal product. The extruded metal product includes a web having a neutral axis, at least one cutout in the web on a first side of the neutral axis, and at least one indentation in the web on a second side of the neutral axis. The at least one indentation is positioned to balance the stress introduced by the at least one cutout.

The present invention provides a metal product that includes desired aesthetic features, such as a cutout, while maintaining a balanced stress to reduce the bowing and bending commonly associated with those features. The method of the present invention reduces bowing and bending while reducing the equipment necessary to provide a flattened product and without significantly increasing the processing time.

These and other objects, advantages, and features of the invention will be readily understood and appreciated by reference to the detailed description of the current embodiments and the drawings.

### BRIEF DESCRIPTION OF THE DRAWINGS

FIG. 1 is a top perspective view of a portion of the metal product according to one embodiment of the present invention.

FIG. 2 is a bottom perspective view of the portion of the metal product thereof.

FIG. 3 is a top plan view of three sections of the metal product according to one embodiment of the present invention.

FIG. 4 is a bottom plan view thereof.

FIG. 5 is an end view of the metal product according to one embodiment of the present invention.

FIG. 6 is a cross sectional view of the metal product taken along line 6-6 in FIG. 4.

FIG. 7 is a cross sectional view of the metal product taken along line 7-7 in FIG. 4.

### DETAILED DESCRIPTION OF THE INVENTION

I. Overview

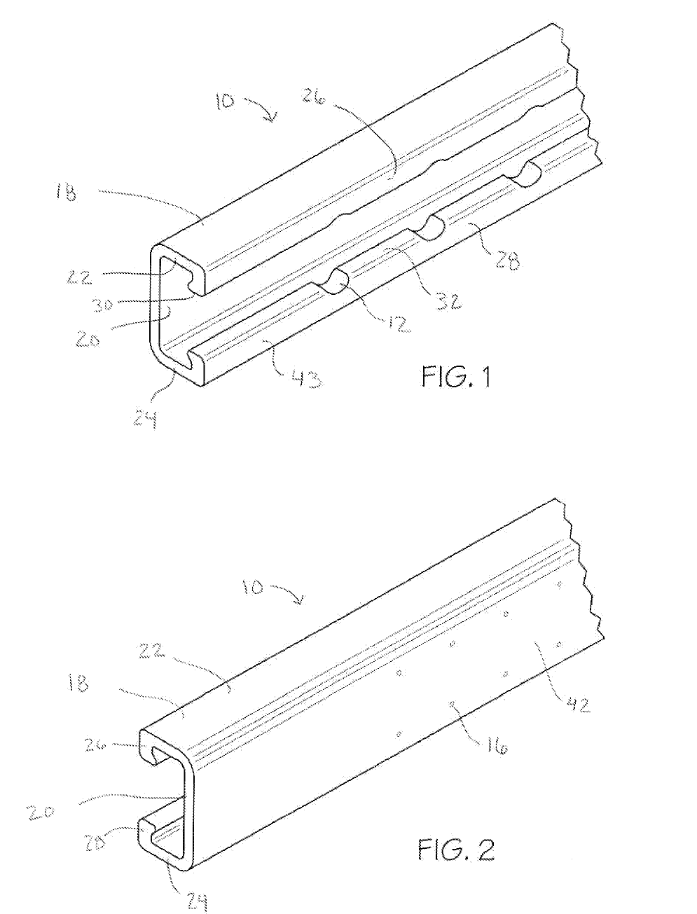

A metal product according to one embodiment of the present invention is shown in FIGS. 1-7 and generally designated 10. In general, the metal product 10 includes a cutout 12 on a first side of the neutral axis 14, and a counter stress feature 16 on a second side of the neutral axis 14. The counter stress feature 16 is positioned to balance the stress introduced on the metal product 10 by the cutout 12. The product 10 is manufactured by the steps of providing a web having a neutral axis; providing a cutout 12 in the web on a first side of the neutral axis 14; and providing a counter stress feature 16 on a second side of the neutral axis 14, with the counter stress feature 16 positioned to balance the stress in the web between the first and second sides of the neutral axis 14.

For purposes of illustration, the present invention is described in connection with one particular embodiment, wherein the metal product 10 is an elongated metal rail 12 having a C-shaped cross section. It will be apparent to those of skill in the art, however, that the invention is applicable to a wide variety of metal products formed from a variety of materials and having a variety of cross sectional configurations. For instance, the product could be aluminum, steel, or a variety of other metals and metal alloys. It could be a flat plate, a tube, or have an asymmetrical shaped cross section.

II. Structure

In the illustrated embodiment, the metal product 10 is a web 18 of metal having a generally C-shaped cross section. As shown, the web 18 includes a central portion 20, a first lateral portion 22 extending at an angle on one side of the central portion 20, and a second lateral portion 24 extending at an angle on the opposite side of the central portion 20 such that the first and second lateral portions are approximately parallel to each other. The first lateral portion 22 includes a first flange portion 26 extending at an angle from the first lateral portion 22. The second lateral portion 24 includes a second flange portion 28 extending at an angle from the second lateral portion 24. The first and second flange portions 26, 28 extend inwardly approximately at right angles from the respective lateral portions 22, 24 to form a channel with a C-shaped cross section. The first flange portion 26 terminates in a first lateral edge 30, and the second flange portion 28 terminates in a second lateral edge 32. In the illustrated embodiment, the metal product 10 has a generally uniform thickness, except that the thickness of the first and second flange portions 26, 28 increases approaching the first and second lateral edges 30, 32.

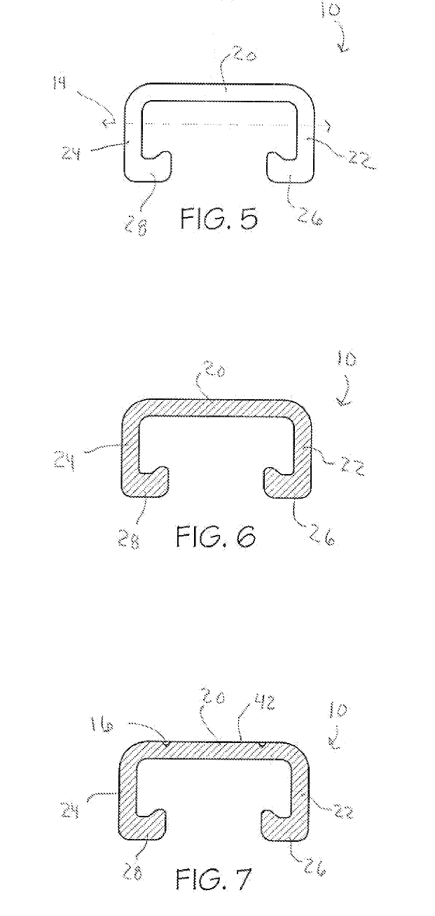

FIG. 5 shows a representation of the neutral axis 14 of the illustrated embodiment. The term neutral axis is known to those skilled in the art as the plane of demarcation across the section of a beam under transverse pressure which experiences neither tension nor compression stresses in the longitudinal direction due to internal moment forces. The neutral axis passes through the centroid of the product. As shown in FIG. 5, in the situation where the metal product 10 is under transverse pressure, the neutral axis 14 is located in a horizontal direction in approximately the position shown. Any plane above or below the neutral axis does receive a stress in bending that varies depending on the distance from the neutral axis. Of course, the position of the neutral axis changes for products with different cross sectional shapes.

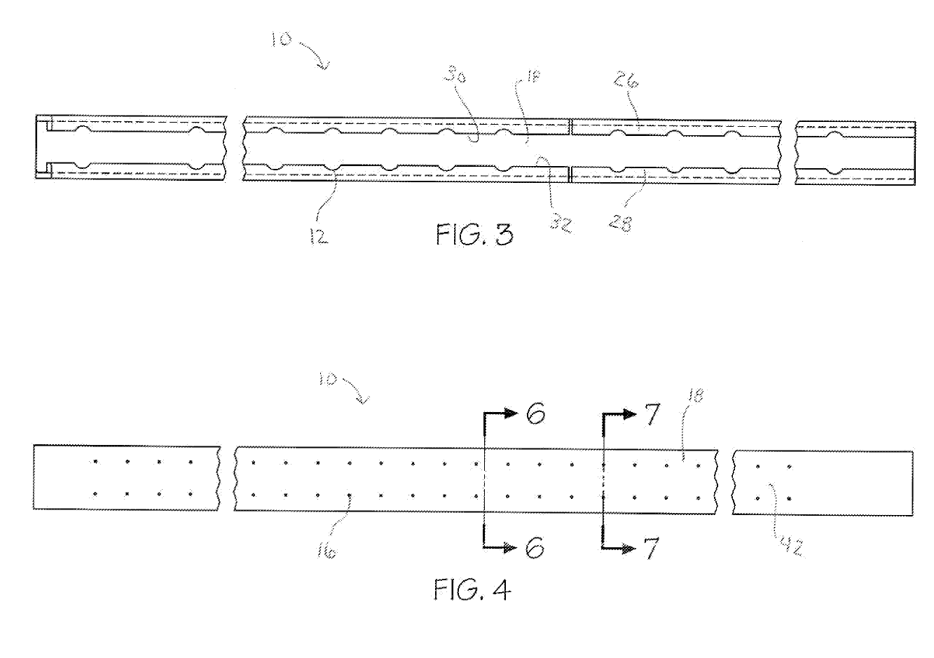

Referring to FIG. 1 and FIG. 3, the metal product 10 includes a plurality of cutouts 12. As illustrated, the cutouts 12 are a plurality of semi-circular shaped notches that are cut into the first and second lateral edges 30, 32 of the first and second flange portions 26, 28. The notches 12 are therefore located above the neutral axis 14 of the metal product 10, such that they introduce stress into the product 10 in a longitudinal direction both above and below the neutral axis 14. In this embodiment, the portion of the product above the neutral axis 14 is under tension stress and the portion of the product 10 below the neutral axis is under a compression stress. The notches 12 are approximately evenly spaced along the length of the metal product 10, with each notch 12 in the first flange portion 30 having a corresponding opposing notch 12 in the second flange portion 32. In the desired final application, the notches 12 may serve a functional purpose, such as allowing an accessory to be attached to the mouth of the C-shaped channel at the location of the notches 12. Alternative embodiments of the C-shaped channel may include notches, holes, or cutouts at different locations on the metal product 10. For instance, one or more holes, notches, or cutouts may be provided in the first and second flange portions 30, 32, or in the first and second lateral portions 26, 28, or in the central portion 20. Additionally, in embodiments where the metal product 10 has a shape other than a C-shaped channel, various combinations of cutouts may be provided. As in the illustrated embodiment, the cutouts 12 may extend through the entire thickness of the product 10, or alternatively, they may extend only partially through the thickness of the product 10.

Referring to FIG. 2, FIG. 4 and FIG. 7, the metal product 10 of the illustrated embodiment also includes a plurality of counter stress features 16. The counter stress features 16 may be one or more cutouts, notches or other stress introducing deformations, and are positioned on the opposite side of the neutral axis 14 as the cutout 12 to balance the stress in the metal product on opposing sides of the neutral axis 14. The tension and compression stresses introduced by the counter stress features 16 act opposite the stress introduced by the cutout 12 to prevent the product from bending or bowing as a result of the cutout 12. In the illustrated embodiment, the counter stress features 16 are a plurality of indentations 16 located on the bottom surface 42 of the central portion 20 of the web 18. The indentations 16 are positioned in two rows, and are approximately evenly spaced along a substantial portion of the length of the metal product 10. Two pairs of indentations 16 are provided on the rear surface 42 for each pair of cutouts 12 on the first and second flange portions 30, 32. In the illustrated embodiment, the counter stress features 16 are located on the rear surface 42 such that they are not visible from the upper surface 43 of the product 10. The spacing, quantity and size of the indentations are determined to introduce a stress on the second side of the neutral axis that appropriately balances the stress on opposing sides of the neutral axis. This determination can be made by calculating the amount of stress introduced by each cutout 12 and each counter stress feature 16, or by trial and error. As shown in FIG. 7, the indentations 16 of the illustrated embodiment are conical in shape. The conical shape allows a manufacturer to gradually change the depth of the penetration to introduce stress until a balance is reached.

III. Method of Manufacture

In general, the metal product 10 of the present invention is manufactured by the steps of: providing a web of metal having a neutral axis; providing a cutout 12 in the web on a first side of the neutral axis 14; and providing a counter stress feature 16 on a second side of the neutral axis 14, with the counter stress feature 16 positioned to balance the stress in the web between the first and second sides of the neutral axis 14.

The web of metal 10 can be provided by a variety of known methods, such as roll forming and extrusion. In the illustrated embodiment, the web 18 having a C-shaped cross section is formed by an extrusion process, wherein a metal material, such as aluminum, is extruded with the desired cross sectional shape and cut to a desired length.

The cutout 12, or a plurality of cutouts 12 and the counter stress feature 16 can be formed in the web 18 by a variety of methods including, for example, punching, coining, shearing, notching, forming, machining. In the illustrated embodiment, the cutouts 12 and the counter stress features 16 are provided by punching. The counter stress features 16 may be punched into the metal product 10 at the same time that the cutouts 12 are punched into the metal product, in order to reduce time in the manufacturing process. As described above, the size, location and quantity of the counter stress features 16 may be predetermined such that when the counter stress features 16 are provided the balance the stress introduced by the cutouts 12.

The above description is that of the current embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A method for manufacturing a metal product with balanced internal stress, comprising:
providing a metal product having a neutral axis;
providing a cutout in the metal product on a first side of the neutral axis, the cutout introducing a stress on the metal product on the first side of the neutral axis;
providing a counter stress feature in the metal product on a second side of the neutral axis, the counter stress feature positioned to introduce a stress to balance the stress introduced by the cutout.

2. The method of claim 1 wherein the step of providing the metal product includes extruding the metal product.

3. The method of claim 1 wherein providing the metal product includes providing a metal product having a central portion and a first lateral portion, the first lateral portion extending at an angle from the central portion, the cutout located in the first lateral portion, the counter stress feature located in the central portion.

4. The method of claim 3 wherein providing the metal product includes providing a second lateral portion opposite the first lateral portion, the first lateral portion including a first flange portion extending from the first lateral portion, the second lateral portion including a second flange portion extending from the second lateral portion, the first and second lateral portions each extending at an angle from the central portion, the first flange portion extending at an angle from the first lateral portion, and the second flange portion extending at an angle from the second lateral portion such that the metal product has a C-shaped cross section, the cutout located on first and second flange portions, the counter stress feature located on the central portion.

5. The method of claim 4 including providing the first flange portion with a first lateral edge and providing the second flange portion with a second lateral edge, and further including providing a plurality of the cutouts, the cutouts defining opposing notches in the first and second edges.

6. The method of claim 1 wherein the step of providing the counter stress feature includes providing an indentation in the metal product.

7. The method of claim 5 wherein the step of providing the counter stress feature includes providing a conical indentation in the metal product.

8. The method of claim 6 wherein providing the conical indentation includes providing a conical indentation of a predetermined size to balance the stress introduced by the cutout.

9. A method for balancing stress in a metal beam, comprising:
extruding a metal beam;
providing a cutout in the extruded metal beam, the cutout introducing a stress in the metal beam;
providing an indentation in the extruded metal beam, the indentation positioned to balance the stress introduced by the cutout.

10. The method of claim 9 wherein the step of extruding the metal product includes extruding a metal product having a central portion and a first lateral portion, the first lateral portion extending at an angle from the central portion, the cutout provided in the first lateral portion, the indentation provided in the central portion.

11. The method of claim 10 including extruding the central portion to include a first surface and a second surface opposite the first surface, the first lateral portion angled toward the first surface, the indentation provided on the second surface.

12. The method of claim 11 including extruding a second lateral portion in the metal product opposite the first lateral portion, extruding a first flange portion extending at an angle from the first lateral portion, and extruding a second flange portion extending at an angle from the second lateral portion, the cutout provided in at least one of the first and second flange portions.

13. An extruded metal piece, comprising:
a web having a neutral axis;
a cutout defined in the web on a first side of the neutral axis; and
an indentation defined in the web on the second side of the neutral axis, the indentation positioned to balance the stress between the first and second sides of the neutral axis.

14. The extruded metal piece of claim 13 wherein the web includes a central portion and a first lateral portion, the first lateral portion extending at an angle from the central portion, the cutout located in the first lateral portion.

15. The extruded metal piece of claim 14 wherein the indentation is located in the central portion.

16. The extruded metal piece of claim 15 wherein the web includes a second lateral portion extending from the central portion opposite the first lateral portion, the second lateral portion extending at an angle from the central portion, the piece defining a plurality of the cutouts, the cutouts located in the first and second lateral portions.

17. The extruded metal piece of claim 16 wherein the central portion includes a first surface and a second surface opposite the first surface, the first and second lateral portions both angled away from the second surface, the indentation located on the second surface.

18. The extruded metal piece of claim 17 wherein the first lateral portion includes a first flange portion extending at an angle from the first lateral portion and the second lateral portion includes a second flange portion extending at an angle from the second lateral portion, such that the web has a C-shaped cross section, the cutouts located on the first and second flange portions.

19. The extruded metal piece of claim 18 including a plurality of indentations, with approximately two of the indentations for each of the cutouts.

20. The extruded metal piece of claim 13 wherein the indentation is conical shaped.
